(19) United States
(12) Patent Application Publication
(10) Pub. No.: US 2026/0022675 A1
(43) Pub. Date: Jan. 22, 2026

(54) SYSTEM AND METHOD FOR ADJUSTING FUEL INJECTOR COMMANDS

(71) Applicant: Caterpillar Inc., Peoria, IL (US)

(72) Inventors: Kaushik KRISHNAMURTHY, Manteno, IL (US); Mitchell B. JUCHEMS, Eureka, IL (US); Michael BARDELL, Vail, AZ (US)

(73) Assignee: Caterpillar Inc., Peoria, IL (US)

(21) Appl. No.: 18/778,341

(22) Filed: Jul. 19, 2024

(51) Int. Cl. F02D 41/28; F02D 41/38; F02D 41/40

(52) U.S. Cl. CPC F02D 41/28; F02D 41/40; F02D 2041/389; F02D 2200/024

(57) ABSTRACT

A system for injecting fuel into an internal combustion engine includes an engine cylinder, a fuel injector configured to inject fuel into the engine cylinder, and a sensor configured to output a signal indicative of a condition associated with the combustion of fuel in the engine cylinder. The system also includes a controller configured to generate commands for an injection of fuel into the internal combustion engine and receive the signal from the sensor. The controller is further configured to generate adjusted commands for: a current amplitude, a start of current time, an end of current time, a duration of a pull-in current, a duration of a keep-in current, or a duration of a hold-in current, for a subsequent injection of fuel into the internal combustion engine, based on the signal from the sensor.

### TECHNICAL FIELD

The present disclosure relates generally to fuel injectors, and more particularly, to a system and method for fuel injector control.

### BACKGROUND

Internal combustion engines configured for direct fuel injection typically include multiple cylinders that are each provided with one or more fuel injectors. These fuel injectors are connected to a control module that monitors and controls operation of the engine. In various engine systems, including those capable of injecting multiple types of fuel, control units can generate commands to valves inside the fuel injector. These commands are generated to inject one or more shots of fuel at a desired timing.

The commands generated by the control unit are, in some systems, identical for each fuel injector. Therefore, the commands do not take into account injector-specific conditions and/or cylinder-specific conditions, which can change over time. Further, the commands do not account for variations in fuel injection quantity or combustion. As such, the commands for these fuel injectors do not compensate for deviations in manufacturing, wear, and changes in the environment that may affect each fuel injector and cylinder differently. Thus, static injector control inputs do not provide desired engine performance in all conditions and may fail to normalize combustion across the cylinders of the internal combustion engine.

U.S. Pat. No. 8,402,939 B2, issued on Mar. 26, 2013 (“the '939 patent”), describes a method and a device for optimizing combustion of diesel fuels with different cetane numbers in a diesel internal combustion engine. The '939 patent provides that cylinder pressures are measured in at least one cylinder of the internal combustion engine during the combustion period. At least one part of the measured cylinder pressures is evaluated in order to derive a characteristic value for the diesel fuel that is fed into the cylinder of the internal combustion engine. This characteristic value is used to change parameters that determine the combustion in the cylinders of the internal combustion engine. The '939 publication does not describe a system and method for modifying fuel injector commands or waveforms.

The system and method of the present disclosure may solve one or more of the problems set forth above and/or other problems in the art. The scope of the current disclosure, however, is defined by the attached claims, and not by the ability to solve any specific problem.

### SUMMARY

In one aspect, a system for injecting fuel into an internal combustion engine may include an engine cylinder, a fuel injector configured to inject fuel into the engine cylinder, and a sensor configured to output a signal indicative of a condition associated with the combustion of fuel in the engine cylinder. The system may also include a controller configured to generate commands for an injection of fuel into the internal combustion engine and receive the signal from the sensor. The controller may be further configured to generate adjusted commands for: a current amplitude, a start of current time, an end of current time, a duration of a pull-in current, a duration of a keep-in current, or a duration of a hold-in current, for a subsequent injection of fuel into the internal combustion engine, based on the signal from the sensor.

In another aspect, a method for adjusting fuel injector commands may include supplying a fuel to a fuel injector of an injection system, and generating commands, with a controller, for a first injection of the fuel by the fuel injector into an internal combustion engine, receiving combustion data, with the controller, from one or more sensors of the injection system. The method may further include determining, with the controller, to adjust the commands based on the combustion data received from the one or more sensors, and adjusting commands, with the controller, for a second injection the fuel into the internal combustion engine.

In yet another aspect, a method for controlling a fuel injector of an internal combustion engine having a plurality of cylinders may include supplying a fuel to the fuel injector, generating a current waveform for actuating a first valve of the fuel injector, measuring combustion of the fuel in a first one of the cylinders of the internal combustion engine with an in-cylinder sensor, and generating an adjusted current waveform for actuating the first valve of the fuel injector based on the measurements made with the in-cylinder sensor.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic diagram of fuel injection system, according to aspects of the disclosure.

FIG. 2 is a partially-schematic cross-sectional view of an exemplary fuel injector of the fuel injection system of FIG. 1.

FIG. 3 is a block diagram of an exemplary engine control module of the fuel injection system of FIG. 1.

FIG. 4 is a plot showing exemplary current waveforms for a pair of valves of the fuel injection system of FIG. 1.

FIG. 5 is a plot showing exemplary current waveforms.

FIG. 6 is a plot showing exemplary pressure values as measured by a sensor of the fuel injection system of FIG. 1.

FIG. 7 is a plot showing exemplary heat density values as measured by a sensor of the fuel injection system of FIG. 1.

FIG. 8 is a flowchart depicting an exemplary method for modifying a fuel injector waveforms, according to aspects of the disclosure.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

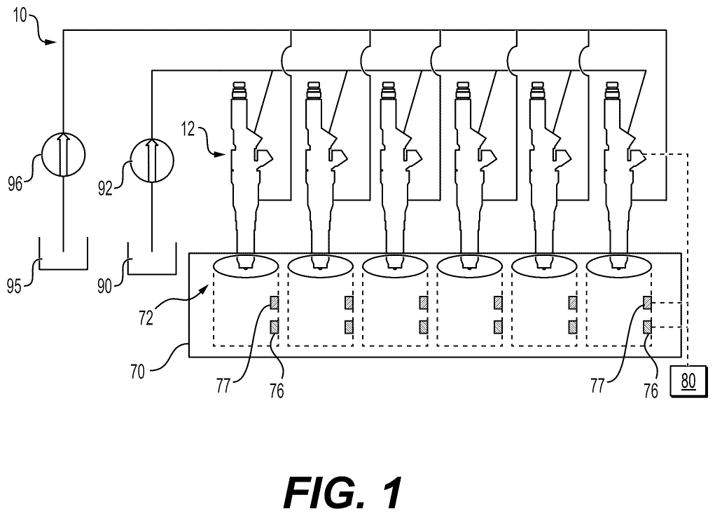

FIG. 1 illustrates an exemplary fuel injection system 10 including an internal combustion engine 70 having a plurality of cylinders 72 and a plurality of fuel injectors 12 and an electronic control module (ECM) 80, according to aspects of the disclosure. Injection system 10 may be an injection system for a single fuel or an injection system configured for injection of multiple fuels (e.g., two fuels), a multi-fuel injection system 10 being illustrated. The fuel injector 12 may include a plurality of electronically-controlled valves, each valve being responsive to commands in the form of waveforms generated with the ECM 80, as described below. The commands to each fuel injector 12 may be varied between subsequent injections in order to normalize the combustion across all cylinders 72 of the internal combustion engine 70 in response to feedback from sensors within the cylinders 72.

As shown in FIG. 1, the multi-fuel injection system 10 includes an internal combustion engine 70 with a plurality of cylinders 72. Each engine cylinder 72 may have at least one associated fuel injector 12 connected for direct fuel injection, and one or more associated sensors configured to detect a condition associated with the combustion of fuel, such as heat sensors 76 and pressure sensors 77. The heat sensors 76 and the pressure sensors 77 may be in electronic communication with the ECM 80 (only one example of each injector 12, sensor 76, and sensor 77 being shown in communication with ECM 80 in FIG. 1).

Multi-fuel injection system 10 may also include a fuel supply system for delivering different fuels to each fuel injector 12. The fuel supply system for delivering may include a pilot fuel reservoir 90 (e.g., a fuel tank), a pilot fuel pump 92, and supply and return lines to each injector 12 for the pilot fuel. The fuel supply system may further include a primary fuel reservoir 95 for a primary fuel, a primary fuel pump 96 downstream of primary fuel reservoir 95, and supply and return lines connected to each injector 12 for the primary fuel. Separate flow paths may supply the pilot and primary fuel to input ports of each fuel injector 12.

As used herein a “primary” fuel refers to a fuel that, under steady state operating conditions of internal combustion engine 70, is injected at a volume that is 50% or more of the total volume of fuel injected into a particular combustion chamber of engine 70 during an injection event that includes a pilot injection (e.g., of diesel fuel) and a main injection (e.g., of methanol). A pilot fuel may be mostly or entirely injected before the primary fuel in an injection event. Additionally, while the terms “pilot fuel” and “primary fuel” may correlate with the orders in which these different fuels are injected, as understood, the pilot injection and primary injection may occur in an overlapping or simultaneous manner, and may include the injection of a mixture of the two fuels for a period of time.

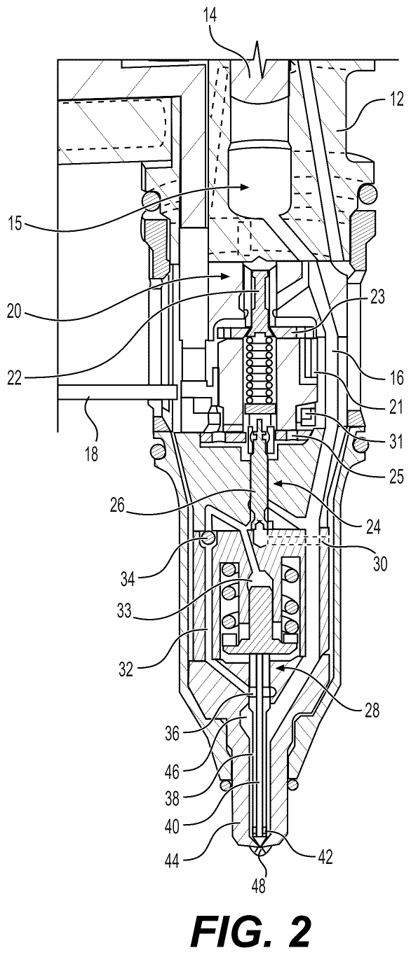

Referring now to FIG. 2, fuel injector 12 may be a mechanically-actuated electronically-controlled unit injector having a spill valve 20, a control valve 24 that is also configured to act as a pilot fuel fill valve, and an injection valve 28 having a hollow interior to facilitate injection of pilot fuel. Fuel injector 12 may include a cam-driven plunger 14, a pressurized fuel passage 16 for primary fuel downstream of plunger 14, and a nozzle 44 forming a distal end portion of fuel injector 12 that is configured to inject both the pilot fuel and the primary fuel in a single injection event.

Fuel injector 12 may be configured to receive primary liquid fuel with a primary fuel connection (not shown). Fuel injector 12 may receive pilot fuel with a pilot fuel inlet or pilot fuel supply connection 18. A pair of separate fuel paths may be formed within fuel injector 12 such that the two fuel paths are isolated from each other, except at nozzle 44 where both fuels may be present at the same time. A fuel path for primary fuel may include a chamber 15 below plunger 14, fuel passage 16, and a nozzle chamber 46. This fuel path may also include spill valve 20 such that spill valve 20 is configured to facilitate pressurization of the primary fuel within fuel injector 12, and facilitate draining of this fuel when pressurization is not desired. For example, a path for draining primary fuel from fuel injector 12 may include spill valve 20 and a primary fuel outlet connection (not shown).

A fuel path for pilot fuel within fuel injector 12 may include pilot fuel supply connection 18, a low-pressure fuel passage 30 (represented with dashed lines in FIG. 2), an injection valve fill passage 32, a control chamber 33, and an injection valve passage 40 formed within a hollow interior of an injection valve 28 that includes radial fuel passage 36 and pilot fuel openings 42. A pilot fuel outlet connection (not shown) may connect fuel injector 12 to downstream components of the pilot fuel portion of fuel supply system.

Spill valve 20 may be a normally-open valve including a spill valve member 22 that is movable between an open position and a closed position. A spring member may act to bias spill valve member 22 to the open position. When the spill valve member 22 is in the open position, fuel passage 16 may be connected to a low-pressure fuel drain, such as a primary fuel connection forming an outlet. When in the closed position, spill valve 20 may prevent the primary fuel from exiting fuel injector 12 via this fuel connection, enabling pressurization of this fuel via plunger 14. Spill valve 20 may be actuated via a spill valve solenoid 21 that actuates a spill valve armature 23 fixed to spill valve member 22.

Control valve 24 may be a second electronically-controlled valve, for example, a direct-operated control (DOC) valve. Control valve 24 may include a control valve member 26 having a non-injection position and an injection position. Control valve member 26 may be configured to connect a low-pressure fuel passage 30 with control chamber 33 when in the injection position, and block the connection between low-pressure fuel passage 30 and control chamber 33 when in the non-injection position.

Control valve 24 may also be configured to control the introduction of pilot fuel into injection valve 28. For example, when in the injection position, control chamber 33 is connected to a low-pressure pilot fuel supply, providing pilot fuel to injection valve 28 via injection valve fill passage 32. Control valve 24 may be actuated via a control valve solenoid 31 between the resting, non-injection, state and the actuated position for injection. A spring member may bias the control valve 24 to the non-injection position.

The actuated position of control valve 24 may also be configured to supply a desired amount of fuel (e.g., pilot fuel) into nozzle 44 in a process referred to as fuel metering. Fuel metering may occur when valve 24 is actuated while fuel injector 12 is not actively injecting fuel (e.g., when spill valve 20 is in a resting, open position). In particular, control valve 24 may be actuated for a period of time, prior to an injection event, to cause fuel from pilot fuel inlet or pilot fuel supply connection 18 to flow through low-pressure fuel passage 30 to a chamber below control valve member 26, as shown in FIG. 2. With control valve member 26 in the actuated position, this pilot fuel may pass from the chamber below member 26 to a one-way valve 34 and subsequently enter injection valve fill passage 32. Fuel may enter radial fuel passage 36 via fill passage 32 and an interior of valve member 38, as described below.

Injection valve 28 may be a one-way valve formed with injection valve member 38, a spring biasing the injection valve member to the non-injection position, and the control chamber 33 at a proximal end of injection valve member 38. Injection valve member 38 may rest in the non-injection position to close orifices 48 of nozzle 44. The injection position may be an open position which opens orifices 48 and allows injection of fuel present in nozzle chamber 46.

Injection valve member 38 may have a needle-like shape that extends from a proximal end abutting control chamber 33 to a distal tip end that opens and closes orifices 48. Injection valve member 38 may have a hollow interior that defines injection valve passage 40. Injection valve passage 40 may be configured to store a quantity of pilot fuel. The hollow interior may extend from a central portion of injection valve member 38 that abuts injection valve fill passage 32 to the distal end of injection valve member 38 within nozzle chamber 46. The proximal portion of injection valve passage 40 may include one or more connecting radial fuel passages 36 in a central portion of injection valve passage 40 that are in fluid communication with injection valve fill passage 32. Injection valve passage 40 may include radially-extending pilot fuel openings 42 at or near the distal end of injection valve member 38. These pilot fuel openings 42 may open into nozzle chamber 46 within nozzle 44.

Fill passage 32 may include one-way valve 34, which allows flow of fluid from control chamber 33 to radial fuel passage 36, but prevents this fuel from returning to control chamber 33 via injection valve fill passage 32. Valve 34 may be a spring-biased valve, the spring not being shown in the figure.

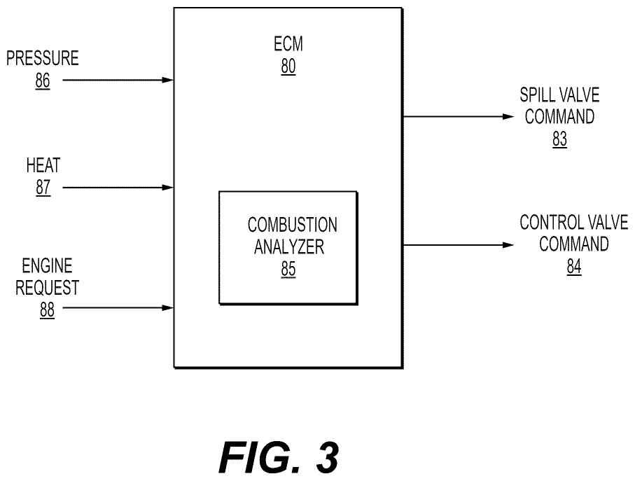

FIG. 3 illustrates a block diagram of an exemplary controller, ECM 80, of the multi-fuel injection system 10. As seen in FIG. 3, the ECM 80 may be an electronic control module that is programmed to control one or more aspects of the multi-fuel injection system 10, including control of fuel injection via fuel injectors 12. ECM 80 may be enabled, via programming, to generate commands that produce current waveforms (also referred to as input waveforms) that control fuel injectors 12 on an individual basis within the multi-fuel injection system 10. For example, the ECM 80 may generate spill valve commands 83 and control valve commands 84 (and corresponding current waveforms) to actuate the spill valve 20 and the control valve 24 of each fuel injector 12 in the multi-fuel injection system 10. ECM 80 may be configured, via programming, to vary the waveforms for each of the spill valves 20 and the control valves 24 within a fuel injector 12. For example, the ECM 80 may vary the amplitude, duration, start, and end of the current supplied to each of the spill valves 20 and the control valves 24 within the fuel injectors 12 on an individual (e.g., valve-by-valve) basis.

ECM 80 may be configured to adjust the commands to the injectors 12 based on inputs to the ECM 80. The inputs may include an engine request 88 that may indicate a desired output related to engine performance, for example, a desired speed. Engine request 88 may correspond to a request from an operator (e.g., by depressing a pedal, moving a lever, etc.), or a value calculated with ECM 80.

The inputs may also include data from sensors within the cylinders 72 of the internal combustion engine 70. For example, the inputs may include heat data 87 (e.g., heat flux) sensed by a heat sensor 76 or pressure data 86 sensed by a pressure sensor 77 within a particular cylinder 72 of the internal combustion engine 70. In at least some configurations, system 10 includes pressure sensors 77 that provide pressure data 86 to a combustion analyzer 85, such that ECM 80 generates commands 83 and 84 with combustion analyzer 85 based on pressure data 86 and engine request 88.

Although the ECM 80 is shown as receiving inputs from a particular cylinder 72 and generating commands for a particular fuel injector 12 in FIG. 1, the ECM 80 may receive inputs from multiple cylinders 72 and sensors 76 and 77 within those cylinders 72. Based on the sensors 76 and 77 for a particular cylinder 72, the ECM 80 may generate commands for each individual fuel injector 12, these commands being adjusted differently for each cylinder. Thus, the ECM 80 may generate independent commands for each fuel injector 12.

The combustion analyzer 85 of ECM 80 may provide functionality for receiving inputs for the ECM 80, determining when combustion variability occurs, and calculating adjustments to the commands 83 and 84 to reduce variability or normalize combustion. The combustion analyzer 85 may evaluate combustion across a plurality of cylinders 72 and identify when one or more individual cylinders 72 deviate, or otherwise present variability, with respect to the remaining cylinders 72. For example, combustion analyzer 85 may be configured to determine when combustion is delayed in an individual cylinder 72 as compared to a desired combustion timing and/or the combustion timing presented by other cylinders 72.

In some embodiments, the combustion analyzer 85 may include a map (e.g., a lookup table, matrix, etc.) that associates the inputs 86-88 to the ECM 80 with combustion conditions, such as variability, with adjustments for commands 83 and/or 84. These maps may be based on data generated for fuel injector 12 according to one or more end-of-line tests, as described below, and may be prepared prior to installation of injector 12. In embodiments, the combustion analyzer 85 may include programmable logic that calculates and outputs command adjustments in an adaptive manner (e.g., to adjust based on feedback from pressure data 86 and/or heat data 87 as described below) based on the inputs to the ECM 80. Adaptive adjustments may be performed with use of one or more maps, data from end-of-line testing, etc. In at least some embodiments, the commands 83 and 84 for each fuel injector 12 may be adjusted iteratively (e.g., in a plurality of steps or increments) until combustion is normalized across each cylinder 72, or until the multi-fuel injection system 10 reaches an optimal or desired state.

As indicated above, commands to fuel injector 12 may be adjusted based on measurements made during end-of-line (“EOL”) tests of the individual fuel injector 12. An EOL test may be a quantitative control task executed at the end of a production line or at another time after manufacture of injector 12. For example, before fuel injector 12 is used in an engine of a machine, one or more EOL tests may be performed on fuel injector 12 to evaluate individual variability of injector 12 (e.g., relatively small differences in the actuation of the spill valve 20, control valve 24, and/or injection valve 28 that occur due to manufacturing tolerances or other manufacturing variations). In some aspects, EOL tests may generate data for implementing combustion analyzer 85, as indicated above.

Any number of EOL tests may be performed on a fuel injector 12 to test fuel injector 12 for any number of qualitative or quantitative metrics or factors. The ECM may receive inputs corresponding to measurements taken during EOL tests, and adjust the commands to the injectors accordingly, each injector 12 being adjusted based on different EOL test data.

The ECM 80 may encompass a single control module, or controller, that controls all of the injectors 12, or separate control modules that control individual fuel injectors 12. As used herein, a “controller” encompasses both single controllers or control modules, or a plurality of controllers or control modules. The ECM 80 may embody a single microprocessor or multiple microprocessors that receive inputs, such as engine requests and data from pressure and/or heat sensors, and generate outputs, such as commands. ECM 80 may include a memory, a secondary storage device, a processor such as a central processing unit, or any other means for accomplishing a task consistent with the present disclosure. The memory or secondary storage device associated with ECM 80 may store data and software to allow ECM 80 to perform its functions, including the functions described with respect to method 900, described below. Numerous commercially available microprocessors can be configured to perform the functions of ECM 80. Various other known circuits may be associated with ECM 80, including current monitoring circuitry, signal-conditioning circuitry, communication circuitry, and other appropriate circuitry.

Although the above-described system 10 includes system capable of injecting multiple different types of fuels, with a dual-fuel injector being shown in FIG. 2, in at least some configurations of this disclosure, system 10 and injector 12 may be configured for delivery of a single type of fuel (e.g., diesel fuel).

### Industrial Applicability

The disclosed aspects of the system and method for modifying fuel injector commands of the present disclosure may be used in conjunction with any appropriate machine, vehicle, or other device or system that includes an internal combustion engine having one or more fuel injectors with at least one electronically-controlled valve. In particular, the system and method for modifying fuel injector commands may be used in any internal combustion engine system in which it is desirable to adjust the waveforms of an electronically controlled valve component, such as a solenoid-actuated valve, based on combustion data gathered by sensors to reduce combustion variability.

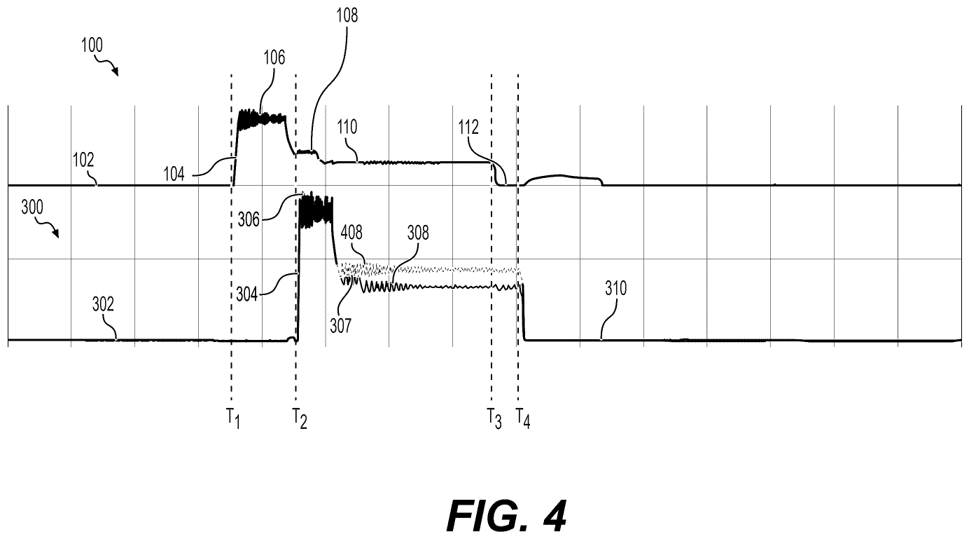

FIG. 4 illustrates exemplary current waveforms for a pair of valves of an injector 12 the fuel injection system of FIG. 1. The upper plot of FIG. 4 includes an exemplary current waveform 100 that represents electrical current supplied to the spill valve 20 (e.g., to solenoid 21 of spill valve 20). The lower plot of FIG. 4 includes an exemplary current waveform 300 that represents electrical current supplied to the control valve 24 (e.g., to solenoid 31 of control valve 24). For clarity, the two plots are separated vertically (i.e., waveforms 100 and 300 are not presented on the same y-axis). The horizontal axis in both plots represents elapsed time for a given engine cycle. Thus, waveforms 100 and 300 share a common x-axis.

Referring now to spill valve waveform 100, a zero-current section 102 represents a period of time before a start of current (SOC) time t₁, described below. During the zero current section 102, no current (or substantially no current) is supplied to the spill valve solenoid 21, such that the spill valve 20 remains in the open position. At the SOC time t₁, the amplitude of the current to the spill valve solenoid 21 begins to increase, resulting in a spill valve ramp up current section 104.

Once a predetermined target current amplitude has been reached, the current may be periodically chopped, forming a series of regularly repeating fluctuations above and below the target current, as represented by spill valve pull-in current section 106. The spill valve 20 reaches a closed position during or shortly after pull-in current section 106.

A keep-in current section 108 may follow the spill valve pull-in current section 106. The keep-in current section 108 may represent a period of time during which the target amplitude of the current applied to the spill valve solenoid 21 is reduced as compared to the pull-in current section 106.

After the keep-in current section 108 is a hold-in current section 110 of the spill valve waveform 100, where the target current is further reduced. At an end of current time t₃, the current supplied to the spill valve solenoid 21 is reduced to zero, or substantially zero, resulting in secondary spill valve zero current section 112. With the current reduced to zero, or substantially zero, the spill valve 20 moves back to the open position.

Referring now to control valve waveform 300, an initial zero current section 302 of the control valve waveform 300 occurs before a start of current time t₂. During the zero current section 302, no current (or substantially no current) is supplied to the control valve solenoid 31, such that the control valve 24 remains in the non-injection position. At the start of current time t₂, the amplitude of the current to the control valve solenoid 31 is increased, resulting in a control valve ramp up current section 304. When a predetermined target amplitude of the supplied current has been reached, the current may be periodically chopped, forming a series of regularly repeating fluctuations above and below a predetermined target current, as represented by control valve pull-in current section 306. The control valve 24 may reach the injection position during or shortly after pull-in current section 306.

A hold-in current section 308 of the control valve waveform 300 follows the valve pull-in current section 306. During hold-in current section 308, the target of the control valve solenoid 31 is reduced from the level of pull-in section 306.

As shown in FIG. 4, if desired, a keep-in current section 307 may also be applied, via ECM 80, prior to hold-in section 308. One or both of keep-in current section 307 and hold-in current section 308 may be modified with ECM 80, resulting in an adjusted current section 408. Exemplary modifications to current waveforms, including increases of current represented by adjusted current section 408, are described below.

At an end of current time t₄, the current supplied to the control valve 24 is reduced to zero, or substantially zero, resulting in a zero current section 310. With the current reduced to zero, or substantially zero, the control valve 24 returns to the non-injection position.

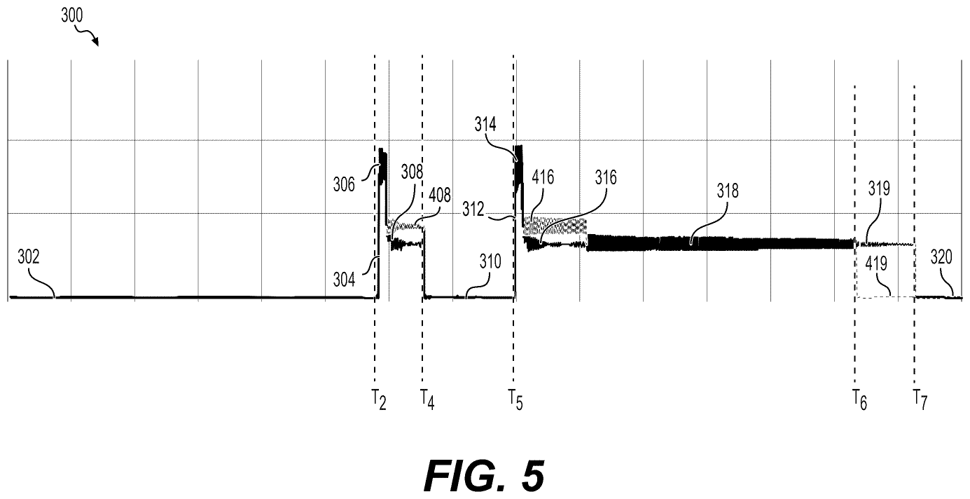

FIG. 5 is a chart showing control valve waveform 300 over a longer period of time as compared to the period of time illustrated in FIG. 4. Waveform 300 of FIG. 5 may include each of the sections illustrated in FIG. 4 and described above.

Waveform 300, as shown in FIG. 5, may include two regions. The first region may occur between times t₂ and t₄, as described above, and may be performed for injecting fuel. A second region between times t₅ and t₇ may be performed for metering fuel (e.g., introducing a desired quantity of pilot fuel from low-pressure fuel passage 30 into nozzle 44 via injection valve passage 40, as described above). Thus, the region of control valve waveform 300 before start of current time t₅ corresponds to a combustion event within the multi-fuel injection system 10. The region of the control valve waveform 300 after start of current time t₅ corresponds to a metering event within the multi-fuel injection system 10.

At start of current time t₅, the amplitude of the current to the control valve 24 is again increased, resulting in a control valve metering ramp-up current section 312, followed by a pull-in current section 314. After the pull-in current section 314, a keep-in current section 316 may be applied, followed by a hold-in current section 318. At an end of current time t₇, the waveform 300 drops to zero current, resulting in zero current section 320. Adjustments to the metering section, represented by an adjusted metering current section 416 and a zero-current adjusted portion 419, described below.

Referring to FIGS. 4-5, the spill valve waveform 100 and control valve waveform 300 may be supplied to each injector 12 over a plurality of engine cycles. The waveforms for injectors 12 of each individual cylinder 72 may be adjusted between cycles and on an injector-by-injector basis. This adjustment may be performed to normalize combustion across the cylinders 72 in response to a determination, with combustion analyzer 85 (FIG. 3), that combustion variability has occurred in a particular cylinder 72.

For some situations, waveforms 100 and 300 remain unaltered between cycles (e.g., when combustion proceeds in an expected manner without significant variability). For example, spill valve waveform 100 (FIG. 4) represents commands issued by ECM 80 without adjustments, such that the various current sections have the same duration, and the current start time t₁ and current end time t₃ remain unchanged.

Control valve waveform 300 (FIGS. 4-5) illustrates exemplary adjustments that may be made with combustion analyzer 85. In the illustrated examples, a first control valve waveform (solid line) may be adjusted to form a second control valve waveform (dashed line). In FIGS. 4 and 5, the current supplied to the control valve solenoid is increased over portions of the control valve waveform 300, such that that the adjusted current section 408 has a larger target amplitude than the target amplitude of first control valve keep-in current section 308. As shown in FIG. 5, an adjusted metering current section 416 has a larger target amplitude than the target amplitude of keep-in current section 316.

Further, as shown in FIG. 5, the duration of the second hold-in current section 318 may be reduced, such that the second control valve waveform 300 reaches an end of current time to before the end current time t₇. This may result in a portion 319 of the first control valve waveform 300 having an increased amplitude relative to a corresponding portion 419 of the second control valve waveform 300. While one example of an end of current time adjustment, time to, is shown, as understood, start of current times and/or other end of current times (e.g., time t₄) may be adjusted.

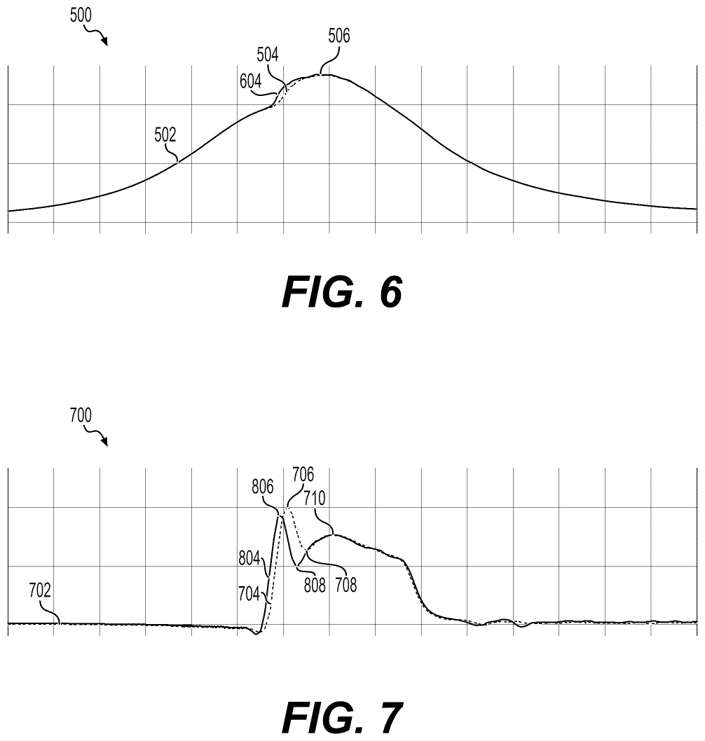

FIG. 6 is a chart illustrating exemplary pressure measurements 500 as measured by the pressure sensor 77 within a particular cylinder of the multi-fuel injection system 10. Combustion analyzer 85 may identify combustion variability based on measurements such as measurements 500, as described below. In FIG. 6, the vertical axis represents the magnitude of the pressure measured by the pressure sensor 78, and the horizontal axis represents time. The pressure measurement 500 includes a bottom rise section 502, a top rise section 504, and a peak 506. Pressure measurements that result from adjusting a current waveform are represented by rise section 604, in which combustion variability is reduced.

FIG. 7 illustrates an exemplary heat measurement 700 (e.g., heat flux) measured with a heat sensor 76 within a particular cylinder 72 of the multi-fuel injection system 10 (FIG. 1). In FIG. 7, the vertical axis represents the amplitude of the heat flux measured by the heat sensor 76, and the horizontal axis represents elapsed time for a given engine cycle. The heat flux measurement 700 has an initial section 702 with a slightly negative slope. The initial section 702 is followed by rise section 704 wherein the heat measured by the heat flux sensor 76 rises at a steeper positive slope. The rise section 704 continues until reaching initial peak 706. After reaching the initial peak 706, the heat measurement 700 proceeds to local minimum 708 before rising again to ensuing peak 710. In the illustrated example, heat flux measurement 700 represents an undesirably-delayed combustion event, such that waveform adjustments result in a more rapid change in heat as represented by rise section 804, peak 806, and local minimum 808, as described below.

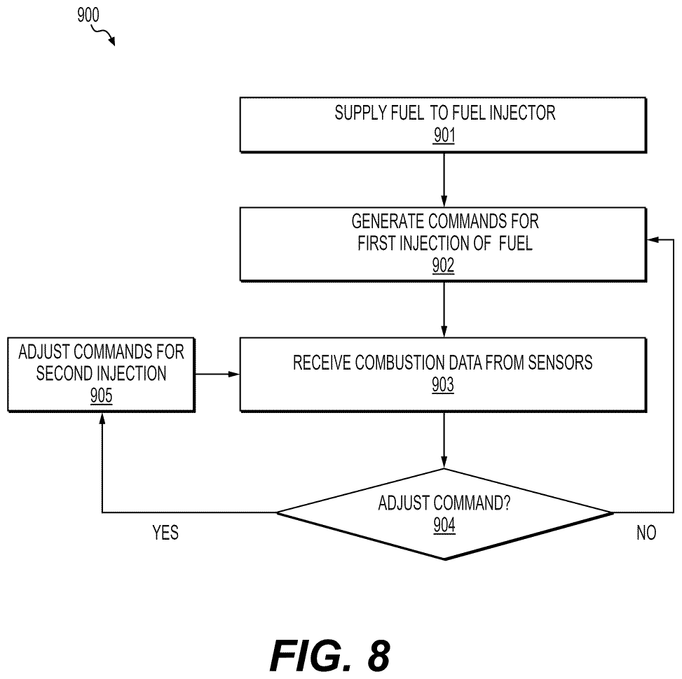

FIG. 8 is a flowchart illustrating an exemplary method 900 for modifying fuel injector commands, or waveforms, of one or more fuel injectors 12 of the multi-fuel injection system 10. In a step 901, a first fuel and a second fuel may be supplied to the fuel injector 12, which may be a dual fuel injector. For multi-fuel operation, the first fuel may be the pilot fuel, and the second fuel may be the primary fuel. The first and second fuel may be supplied to the fuel injector 12 as described above. In at least some embodiments of method 900, the fuel injector 12 is a single-fuel injector, or a multi-fuel injector operating in a single fuel mode, such that only one fuel is supplied to the fuel injector 12 in step 901. Steps 902-905, described below, are similarly applicable to a single-fuel injector or multi-fuel injector operating in a single fuel mode.

In a step 902, the ECM 80 may generate commands for a first injection of the first fuel and the second fuel via fuel injector 12. The commands for injection of the first fuel and the second fuel may be stored in the memory of the ECM 80, and/or may be generated based on the inputs to the ECM 80. The commands may include one or more of: the current amplitude (e.g., target current, upper limit for chopped current, lower limit for chopped current, etc.), the start of current time, the end of current time, or the current section duration. These commands may be represented in the above-described current waveforms, such as the spill valve waveform 100 of FIG. 4 and the control valve waveform 300 of FIGS. 4-5. In particular, the waveforms may include one or more of: pull-in current sections 106, 306; keep-in current sections 108, 308; or hold-in current sections 110. Additionally or alternatively, the waveforms may include metering events that may include a pull-in current section 314, a keep-in current section 316, and a hold-in current section 318. While three sections with generally constant amplitudes are illustrated in FIGS. 4-5, as understood, the waveforms described herein may include four sections (e.g., four amplitude tiers), or a greater number of sections. Further, when adjustments are made for an injection event, the adjustments may be made for a pilot injection, main injection, and/or a post-main injection of fuel.

The commands may control the spill valve 20 and the control valve 24 for one or more fuel injectors 12. For example, the ECM 80 may generate a waveform 100 for the spill valve 20 and waveform 300 for the control valve 24. In controlling the spill valve 20 or the control valve 24, the commands may adjust the amplitude and duration of the current supplied to either or both of the spill valve solenoid 21 or the control valve solenoid 31. By controlling the current supplied to the spill valve solenoid 21 and the control valve solenoid 31, the commands may be used to control the opening and closing of the spill valve 20 and the control valve 24, respectively. In at least some embodiments, step 902 includes generating commands for metering fuel via control valve 24, instead of or in addition to commands for injecting fuel.

In a step 903, the ECM 80 may receive combustion data from the sensors within the internal combustion engine 70. The combustion data may include the pressure data 86 from the in-cylinder pressure sensor 77 or heat data 87 from the in-cylinder heat sensor 76. In other examples, the combustion data may include other types of data from other sensors within the multi-fuel injection system 10. The combustion data received in step 903 may include values sensed with a sensing device (e.g., sensor 76 or sensor 77), calculated values, or both. Additionally, data may be received from sensors that are located outside of cylinders of the engine 70, such as exhaust temperature sensors (e.g., individual sensor connected to branches of an exhaust manifold).

At step 904, the ECM 80 may determine whether adjustments to the commands, such as adjustments to the first spill valve waveform 100 and the first control valve waveform 300, are desired. The determination to adjust the waveform(s) may be based on the combustion variability identified with combustion analyzer 85 according to signals from sensors for each of the cylinders 72. Additionally or alternatively, the determination may be based on the differences between the expected combustion data for a particular cylinder 72 and the sensor input for that cylinder 72 to the ECM 80.

If the ECM 80 determines in step 904 that no changes to the input commands are necessary, the method may return to step 902 such that the ECM generates commands for injection of the pilot fuel and primary fuel without adjustment. For example, the commands may be the same as those previously generated, or in accordance with default values. In this second or subsequent performance of step 902, the ECM 80 may generate a second spill valve waveform 100 and control valve waveform 300 that are substantially identical to the first second spill valve waveform 100 and control valve waveform 300 used in the previous engine cycle.

If the ECM 80 determines in step 904 that command adjustments are desirable, then a step 905 may be performed. In step 905, the ECM 80 may adjust the commands for the second injection of the pilot fuel and/or the primary fuel, or a second metering event, for one or more of the spill valve 20 or the control valve 24. The ECM 80 may modify or adjust one or more of: the current section amplitude one or more current sections (e.g., sections 104, 106, 108, 110, 304, 306, 307, 308), the start of current time, end of current time, or current section duration. In adjusting the commands, the ECM 80 may generate a second spill valve waveform 100 and/or a second control valve waveform 300 that is different from the first spill valve waveform 100 and first control valve waveform 300, respectively.

The commands may be adjusted for each individual fuel injector 12 such that different adjustments are made to different injectors 12 in the same engine 70. If adjustments are made to waveforms for both, the spill valve 20 and the control valve 24 of the same injector 12, the adjustments to the spill valve and control valve waveforms may be different from each other.

ECM 80 may adjust a current section amplitude by increasing or decreasing one or more of the target currents for the pull-in current section, hold-in current section, or keep-in current section for one or more subsequent injections. ECM 80 may adjust a duration of one or more of the current sections by increasing or decreasing the duration (as measured with respect to crankshaft position) of one or more of a pull-in current section, a hold-in current section, a keep-in current section, or a combination thereof. ECM 80 may adjust the start of current by adjusting the time of the engine cycle at which the current begins to be applied to spill valve solenoid 21 or control valve solenoid 31, represented by an initial increase in current ramp up sections. ECM 80 may adjust the end of current timing by adjusting the time within the engine cycle at which the current is no longer applied to spill valve solenoid 21 or control valve solenoid 31. ECM 80 may be configured to adjust the commands and waveforms for any event during an engine cycle, so as to alter an injection event or a metering event during engine operation.

For example, as shown in FIGS. 4-5, the ECM 80 may adjust the control valve waveform 300 for a fuel injector 12, such that the amplitude of an adjusted current section 408 is higher than that of the keep-in current section 308, causing the control valve 24 to remain in the injection position with increased stability. With reference to FIG. 6, the change in amplitude of the adjusted current section 408 (FIG. 4) may cause the slope of the rise section 604 of pressure measurement 700 to increase at an earlier time (e.g., in comparison to section 704), due to more consistent combustion that occurs based on improved stability of the control valve 24. As shown in FIG. 7, the change in amplitude of the adjusted current section 408 (FIG. 4) may improve combustion stability as represented by the rise section 804 and the magnitude and/or timing of initial pressure peak 806 (e.g., in comparison to peak 706).

With reference to FIG. 5, the ECM 80 may supply current in an adjusted current section 416 with an increased amplitude that more reliably supplies fuel, allowing a shorter-duration metering event and earlier zero-current portion 419. This may provide the benefits described with respect to FIGS. 6 and 7, and/or otherwise reduce combustion variability.

The adjustments to the commands and waveforms may reduce the variability of combustion for each cylinder 72, and therefore normalize combustion across all of the cylinders 72. In some embodiments, the ECM 80 may iteratively adjust the commands and waveforms of subsequent injections of the first fuel and the second fuel until the combustion is normalized across the cylinders 72, or until the internal combustion engine 70 reaches an optimal or desired state. For example, the commands may be iteratively adjusted until a coefficient of variation, calculated with combustion analyzer 85, between cycles is reduced to within a certain threshold. In other embodiments, adjustments to the commands may be made by comparing combustion data to one or more maps of the combustion analyzer 85, as described above.

By adjusting commands for a fuel injector, the disclosed system and method may normalize engine combustion across a plurality of engine cylinders. This may reduce cylinder-to-cylinder differences and improve engine performance. Reduction in variation may also reduce the generation of undesirable compounds, improving emissions. The ability to adjust different sections of an injector waveform may provide the ability to correct for different causes of variability, such as changes in engine conditions, injector wear, vibration, changes in fuel quality, etc. Adjustments to metering may facilitate injection of two fuels reliability, improving pilot fuel injection and generation of a pilot flame that facilitates complete combustion of the primary fuel.

It will also be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A system for injecting fuel into an internal combustion engine, the system comprising:
an engine cylinder;
a fuel injector configured to inject a fuel into the engine cylinder;
a sensor configured to output a signal indicative of a condition associated with the combustion of fuel in the engine cylinder; and
a controller configured to:
generate commands for an injection of the fuel into the internal combustion engine;
receive the signal from the sensor; and
generate adjusted commands for: a current amplitude, a start of current time, an end of current time, a duration of a pull-in current, a duration of a keep-in current, or a duration of a hold-in current, for a subsequent injection of the fuel into the internal combustion engine, based on the signal from the sensor.

2. The system of claim 1, wherein the sensor is an in-cylinder pressure sensor or a heat sensor.

3. The system of claim 2, wherein the controller is configured to identify combustion variability in the engine cylinder based on the signal and generate adjusted commands based on the identified variability.

4. The system of claim 2, wherein the controller is configured to inject a pilot fuel and a primary fuel and to generate adjusted commands for injecting at least the pilot fuel.

5. The system of claim 1, wherein the adjusted commands for the subsequent injection of the fuel include an adjustment to at least one of: a current amplitude, a start of current time, an end of current time, or a duration of a pull-in current, a keep-in current, or a hold-in current.

6. The system of claim 1, wherein the fuel injector is configured to inject both a first fuel and a second fuel, and the adjusted commands are generated for at least one of a spill valve or a control valve.

7. The system of claim 1, wherein the controller is further configured to generate the adjusted commands in response to identifying combustion variability based on in-cylinder pressure that is indicated by the signal.

8. A method for adjusting fuel injector commands, the method comprising:
supplying a fuel to a fuel injector of an injection system;
generating commands, with a controller, for a first injection of the fuel by the fuel injector into an internal combustion engine;
receiving combustion data, with the controller, from one or more sensors of the injection system;
determining, with the controller, to adjust the commands based on the combustion data received from the one or more sensors; and
adjusting commands, with the controller, for a second injection the fuel into the internal combustion engine.

9. The method of claim 8, wherein the commands for injection of the fuel include an adjustment to one or more of: a current amplitude, a start of current time, an end of current time, or a duration of a pull-in current, a keep-in current, or a hold-in current.

10. The method of claim 8, wherein the fuel is a first fuel and the method includes supplying a second fuel to the fuel injector, the commands controlling at least one of a spill valve or a control valve of the fuel injector.

11. The method of claim 8, wherein the combustion data includes in-cylinder pressure data.

12. The method of claim 8, wherein the commands for injections of the fuel following the first injection are adjusted iteratively.

13. A method for controlling a fuel injector of an internal combustion engine having a plurality of cylinders, the method comprising:
supplying a fuel to the fuel injector;
generating a current waveform for actuating a first valve of the fuel injector;
measuring combustion of the fuel in a first one of the cylinders of the internal combustion engine with an in-cylinder sensor; and
generating an adjusted current waveform for actuating the first valve of the fuel injector based on the measurements made with the in-cylinder sensor.

14. The method of claim 13, wherein the waveform is adjusted during an injection event for the fuel injector.

15. The method of claim 13, wherein the first valve is a control valve and the adjusted current waveform causes the control valve to actuate to meter the fuel to a nozzle of the fuel injector.

16. The method of claim 15, wherein the fuel is a pilot fuel and the method further includes supplying a second fuel to the fuel injector.

17. The method of claim 13, wherein the adjusted current waveform includes a change to at least one of a pull-in current section, a keep-in current section, or a hold-in current section.

18. The method of claim 13, wherein the adjusted current waveform includes a change to at least one of a current amplitude or a current duration.

19. The method of claim 13, further including identifying combustion variability with the in-cylinder sensor, wherein the current waveform is adjusted in response to identifying the combustion variability.

20. The method of claim 13, further including adjusting a current waveform for actuating a second valve of a second fuel injector, the adjustment for actuating the first valve being different than the adjustment for the second valve.
